(19) United States
(12) Patent Application Publication
(10) Pub. No.: US 2019/0113293 A1
(43) Pub. Date: Apr. 18, 2019

(54) TRAFFIC-VARYING FLOW-ADAPTIVE SPRAY NOZZLE HAVING GUIDING AND SPREADING FUNCTIONS CAPABLE OF GUIDING FLOWS AND CONDUCTING SPREAD

(71) Applicant: SHANGHAI ACE COOLING REFRIGERATION TECHNOLOGY CO., LTD., Shanghai (CN)

(72) Inventors: Yongsheng Chen, Shanghai (CN); Jing Zeng, Shanghai (CN); Feng Li, Shanghai (CN)

(21) Appl. No.: 16/066,916

(22) PCT Filed: Dec. 21, 2016
(86) PCT No.: PCT/CN2016/111305

§ 371 Date: Dec. 10, 2018

(30) Foreign Application Priority Data
Dec. 28, 2015 (CN) 201511005934.5

(51) Int. Cl. F28F 25/06; B05B 1/26

(52) U.S. Cl. CPC F28F 25/06; B05B 1/265

(57) ABSTRACT

A traffic-varying flow-adaptive spray nozzle includes a spray pipe, a fluid direction-change accelerator connected to the lower part of the spray pipe, and a tension eliminator disposed on the fluid direction-change accelerator. A water inlet is arranged in the upper portion of the spray pipe, and a water outlet is arranged in the bottom of the spray pipe. The center position of a waterward water-facing surface of the fluid direction-change accelerator is higher than the edge portion, and the center position of the waterward water-facing surface transits to the edge portion by means of a parabolic surface. The tension eliminator protrudes from the waterward water-facing surface.

This application claims priority to Chinese Patent Application No. 201511005934.5 titled “VARIABLE FLOW RATE SPRAY NOZZLE HAVING FLOW GUIDING AND DIFFUSING FUNCTIONS”, and filed with the State Intellectual Property Office of People's Republic of China on Dec. 28, 2015, which is incorporated herein by reference in its entirety.

### FIELD

The present application relates to the technical field of cooling towers, and in particular to a variable flow rate spray nozzle having flow guiding and diffusing functions.

### BACKGROUND

The working principle of a cooling tower is that air is blown to the sprayed water from a suitable angle, and when the air passes through the water droplets, part of the water evaporates. Since heat is consumed in evaporating the water, the temperature of the water is decreased, and the remaining water is cooled down.

In the working process of the cooling tower, the water pump presses the circulation water into a water distribution tray of the cooling tower through a pipeline with a certain pressure, and the water is uniformly sprayed on the packing through the spray nozzles on the water distribution tray. After the circulation water is sprayed by the spray nozzles, a water film is formed on the surface of the packing, and the circulation water exchanges heat with the air sucked into the tower by a fan, thereby cooling the cooling water.

The conventional cooling tower water distribution spray nozzles are of a reflective type or a drip-splashing type. The water splashing tray for the two types of spray nozzles is of an energy-dissipation type. However, when the real-time water volume deviates from the standard water volume to a certain level, for instance, when the real-time water volume merely attains smaller than 70% of the standard water volume, the two types of spray nozzles cannot uniformly distribute water. Since the water level pressure is low and the kinetic energy is insufficient, the water tension cannot be overcome at the water splashing tray, and the water flow twists into a ball and the shape of the sprayed water is merely a small solid circle. When the real-time water volume is greater than 70% of the standard water volume and the water pressure in the water distribution tray is relatively high, the water sprayed by the spray nozzles in the conventional technology may form a large hollow circle, and the part, corresponding to the hollow portion of the hollow circle, of the packing may be remained a water-free region. Due to the non-uniform water distribution, water-intensive region and water-free region are formed in the packing. In the water-intensive region, the air resistance increases and the ventilation rate becomes smaller due to the increase of water volume, on the contrary, the air resistance in the water-free region becomes smaller and an air short circuit occurs, causing degradation of the cooling effect of the whole tower and ultimately resulting in energy waste.

The working principle of a conventional cooling tower spray nozzle is to make the water collide with the water splashing tray to expand the range of water spraying. During the collision, a large amount of small water droplets will be splashed, these small water droplets dispersed in the high-speed flowing air will be taken away by the air, causing a water drifting loss and directly resulting in waste of water resources.

Therefore, an important technical issue to be addressed by the person skilled in the art is to address the issue in the conventional technology that the water sprayed from the spray nozzle is non-uniformly distributed on the packing when the real-time water volume is a non-standard water volume.

### SUMMARY

In order to address the above technical issues, a variable flow rate spray nozzle having flow guiding and diffusing functions is provided according to the present application, which can avoid the issue of non-uniformly water spraying caused by the real-time water pressure being a non-standard water pressure, and can uniformly spray water on the surface of the packing when the real-time water volume ranges from 10% to 150% of the standard water volume, without forming a large hallow circle or a small solid circle, which can maximize the cooling performance for cooling the packing.

A variable flow rate spray nozzle having flow guiding and diffusing functions according to the present application includes a spray tube, provided with a water inlet at an upper part and a water outlet at a bottom part; a diverting accelerator connected to a lower side of the spray tube; and a tension eliminator arranged on the diverting accelerator. A water-facing surface of the diverting accelerator has a central portion higher than an edge portion thereof, and the central portion of the water-facing surface is transitioned to the edge portion through a paraboloid to guide the water flow flowing down in a vertical direction to be gradually diverted to the horizontal direction through the paraboloid, the tension eliminator protrudes from the water-facing surface, and the tension eliminator has a first end close to the central portion and a second end close to and protruding from the edge portion, and the tension eliminator has a thickness gradually increasing from top to bottom and gradually increasing from the central portion to the edge portion of the water-facing surface.

Preferably, the water outlet of the spray tube is smaller than the water inlet, and an inner side wall of the spray tube is provided with a spiral guiding groove, and the water flowing into the spray tube flows downward in a spiral direction along the spiral guiding groove.

Preferably, the number of the tension eliminator is plural, and the tension eliminators are distributed on the water-facing surface in a circumferential direction with the central portion as the center of a circle.

Preferably, any one of the tension eliminators is a triangular cone having a first vertex, a second vertex, a third vertex, and a fourth vertex, and a line connecting any two vertices is an edge of the triangular cone, the first vertex, the second vertex and the third vertex are arranged on the water-facing surface, and the first vertex is close to the central portion, the second vertex and the third vertex are close to the edge portion, and the fourth vertex protrudes from the water-facing surface.

Preferably, the projection of the fourth vertex in the vertical direction is beyond the water-facing surface.

Preferably, a line connecting the first vertex with the second vertex has a length equal to the length of a line connecting the first vertex with the third vertex, and the fourth vertex is located on a symmetry plane of a triangle defined by the first vertex, the second vertex, and the third vertex.

Preferably, a line connecting the fourth vertex with the first vertex is tangent to a water through hole.

Preferably, a line connecting the fourth vertex with the first vertex intersects with a centerline of the water through hole.

Preferably, the central portion of the diverting accelerator is provided with a water through hole which penetrates the central portion in the vertical direction, and the water through hole of a lower stage has a diameter smaller than the diameter of the water through hole of an upper stage.

Preferably, the water through hole is a taper hole whose diameter gradually decreases from top to bottom.

Preferably, an upper part of the water through hole is an acute angular edge to facilitate distributing part of the water flow to a lower stage of diverting accelerator.

Preferably, the diverting accelerator includes at least two stages of diverting accelerators, and the stages of diverting accelerators are distributed in the vertical direction, and each of the stages of diverting accelerators is provided with a tension eliminator.

Preferably, the diverting accelerator includes multiple stages of diverting accelerators, each of the stages of diverting accelerators is provided with a tension eliminator, and the multiple stages of diverting accelerators are sequentially connected in the vertical direction.

Preferably, two adjacent stages of diverting accelerators are connected by a first connecting post.

Preferably, the spray tube is provided with a flange, and the flange may be arranged on an upper or middle or lower part of the spray tube as required.

Preferably, the flange arranged on the spray tube may be substituted by screw threads for mounting the spray tube in other occasions.

Preferably, an uppermost stage of diverting accelerator is connected to the flange by a second connecting post.

Preferably, the flange and the second connecting post are snapped together by a snap joint and a snap groove.

In such an arrangement according to the technical solution of the present application, the water in the water distribution tray enters from the water inlet of the spray tube and flows out from the water outlet, and falls on the water-facing surface of the diverting accelerator. Since the water-facing surface is a tapered surface which gradually expands from top to bottom, a water flow flowing down in the vertical direction can be further guided in being gradually diverted to the horizontal direction through the tapered surface, thus, a direction diversion of the fluid can be achieved with a lowest possible speed loss, and hydrokinetic energy can be maximumly utilized to diffuse the water in a predetermined water distribution region.

Moreover, the water may become tangent to the tension eliminator in the diverting process. Since the thickness of the tension eliminator gradually increases from top to bottom, and also gradually increases from the central portion to the edge portion of the water-facing surface, a water film which is originally shrunk due to a water tension is divided into multiple water flows by the tension eliminator having the gradually increased thickness on the water-facing surface when water flows on the water-facing surface, to ensure that water can be sprayed in the predetermined region even in a real-time working condition with a low water flowing speed. Also, since the resistance encountered by the water flow is small, the water flow is prevented from shrinking into a mass to form a small solid circle due to a tension concentration thereof. Therefore, the variable flow rate spray nozzle having flow guiding and diffusing functions according to the present application can spray a water flow farther and more uniformly.

### BRIEF DESCRIPTION OF THE DRAWINGS

FIG. 1 is a partial sectional view of a diverting accelerator and a tension eliminator according to an embodiment of the present application.

FIG. 2 is a top view of a diverting accelerator and a tension eliminator according to an embodiment of the present application.

FIG. 3 is a schematic view of a variable flow rate spray nozzle having flow guiding and diffusing functions with three stages of diverting accelerators according to an embodiment of the present application.

FIG. 4 is a partial sectional view of a variable flow rate spray nozzle having flow guiding and diffusing functions with three stages of diverting accelerators according to an embodiment of the present application.

FIG. 5 is a schematic view of a variable flow rate spray nozzle having flow guiding and diffusing functions with two stages of diverting accelerators according to an embodiment of the present application.

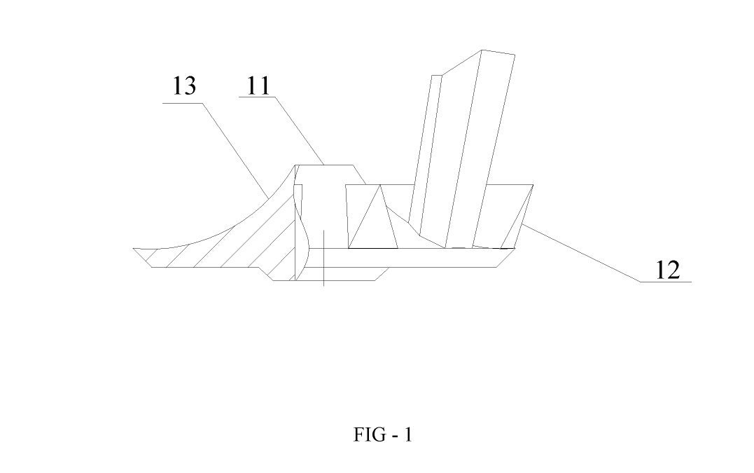

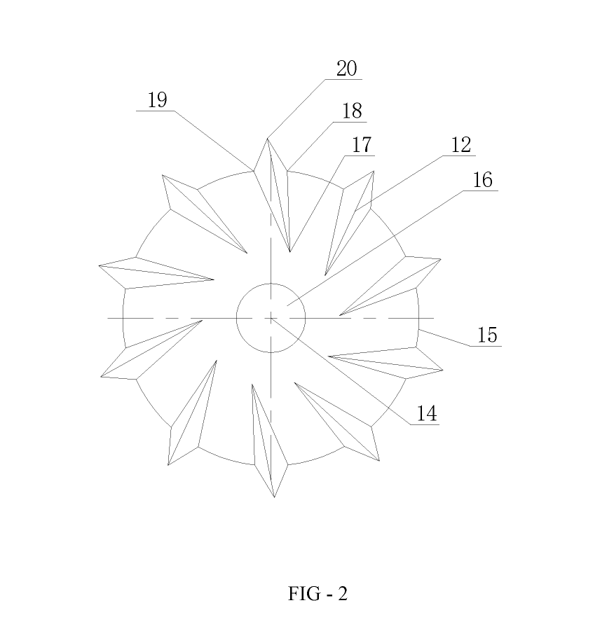

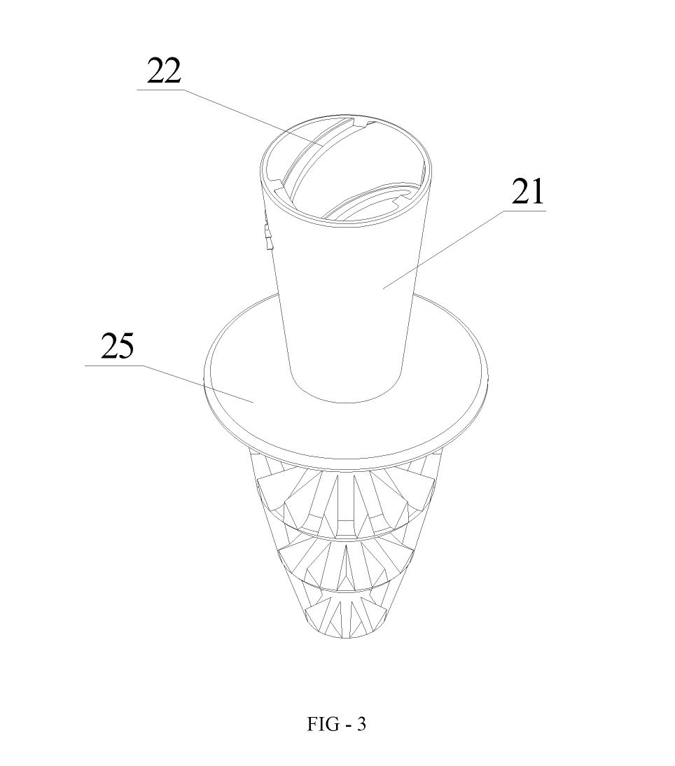

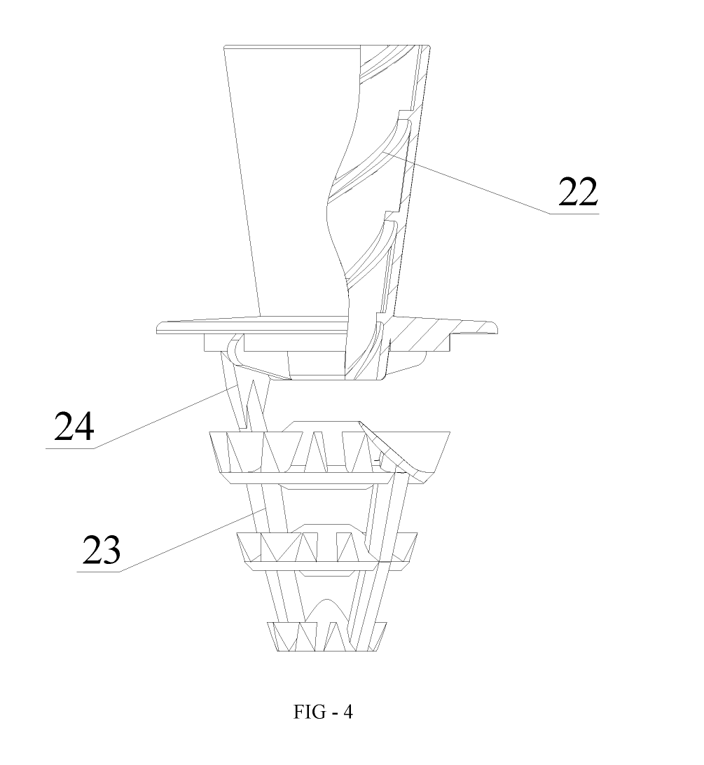

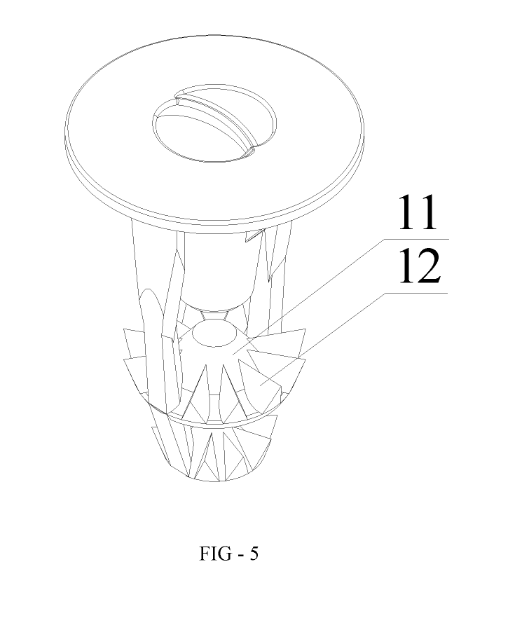

Reference numerals in FIGS. 1 to 5:

| | |
|---|---|
| 11 diverting accelerator, | 12 tension eliminator, |
| 13 water-facing surface, | 14 central portion, |
| 15 edge portion, | 16 water through hole, |
| 17 first vertex, | 18 second vertex, |
| 19 third vertex, | 20 fourth vertex, |
| 21 spray tube, | 22 spiral guiding groove, |
| 23 first connecting post, | 24 second connecting post, and |
| 25 flange. | |

### DETAILED DESCRIPTION OF EMBODIMENTS

A variable flow rate spray nozzle having flow guiding and diffusing functions is provided according to this embodiment, which can avoid the issue of non-uniform water spraying caused by a real-time water pressure being a non-standard water pressure.

The technical solutions in the embodiments of the present application will be described clearly and completely hereinafter in conjunction with the drawings in the embodiments of the present application. Apparently, the described embodiments are only a part of the embodiments of the present application, rather than all embodiments. Based on the embodiments in the present application, all of other embodiments, made by the person skilled in the art without any creative efforts, fall into the scope of protection of the present application.

Referring to FIGS. 1 to 5, a variable flow rate spray nozzle having flow guiding and diffusing functions according to this embodiment includes a spray tube 21, a diverting accelerator 11 connected to a lower side of the spray tube and a tension eliminator 12 arranged on the diverting accelerator 11.

A water inlet is provided at an upper part of the spray tube 21 with at and a water outlet is provided at a bottom part of the spray tube 21. An inner side wall of the spray tube 21 is provided with a spiral guiding groove 22, and water flowing into the spray tube flows downward in a spiral direction along the spiral guiding groove 22.

A water-facing surface 13 of the diverting accelerator 11 has a central portion 14 higher than an edge portion 15, and the central portion 14 of the water-facing surface 13 is transitioned through a paraboloid to the edge portion 15, so as to guide the water flow flowing in a vertical direction in being gradually diverted to a horizontal direction through the paraboloid.

It should be noted that the above water-facing surface 13 is a paraboloid capable of guiding a vertical water flow and gradually changing its direction into a horizontal water flow. Specifically, the paraboloid can be set such that in any one of longitudinal sections of the diverting accelerator 11, the central portion 14 of the water-facing surface 13 is transitioned along a curved line toward the edge portion 15, and a midpoint of a line connecting two ends of the curved line is higher than a midpoint of the curved line. The water-facing surface 13 of such a structure can gradually change the direction of the water flow from vertical to horizontal. Of course, the paraboloid may also have a structure similar to an outer peripheral curved surface of a cone.

The tension eliminator 12 protrudes from the water-facing surface 13. The tension eliminator 12 has a first end close to the central portion 14 and a second end close to the edge portion 15. The tension eliminator 12 has a thickness gradually increasing from top to bottom and also gradually increasing from the central portion 14 to the edge portion 15 of the water-facing surface 13. A water flow flows from top to bottom and from the central portion 14 to the edge portion 15. The tension eliminator 12 can gradually divide the water flow into two parts, and allow the water flow to encounter less resistance, thus energy consumption in flow division is reduced.

In addition, in this embodiment, a central portion of the diverting accelerator 11 may be provided with a water through hole which penetrates the central portion from top to bottom, and the water through hole of a lower stage has a diameter less than the diameter of the water through hole of an upper stage. It should be noted that the water through hole 16 in the central portion of the diverting accelerator 11 may have an increased diameter, a decreased diameter or even be canceled according to application requirements. Providing the water through hole 16 in the diverting accelerator 11 may prevent water from forming a hollow circle after the water is sprayed. Moreover, in this embodiment, the diverting accelerator 11 may be arranged as two stages in an up and down direction, and each of the stages of the diverting accelerators 11 is provided with a tension eliminator. Of course, the number of stage of the diverting accelerator 11 may also be one, three, or four etc., which may be set according to specific conditions, and will not be specifically described herein.

With such an arrangement, in the technical solution according to this embodiment, water in the water distribution tray enters the spray tube 21 through the water inlet of the spray tube 21, and since the inner side wall of the spray tube 21 is provided with the spiral guiding groove 22 which spirally extends downwards from an upper end to a lower end of the spray tube, the water entering the spray tube 21 spirally flows along the spiral guiding groove 22, generating vortex effect which increases the centrifugal force of the water, so as to ensure a water dispersing area.

When the water flows out of the spray tube 21 and then falls on the water-facing surface 13 of the diverting accelerator, the water flow first comes into contact with the central portion 14 and flows along the water-facing surface 13 toward the edge portion 15 of the water-facing surface 13 since the central portion 14 of the water-facing surface 13 is higher than the peripheral edge portion 15. Since the water-facing surface 13 is a paraboloid capable of gradually changing the direction of the water flow from vertical to horizontal, the water flow can flow along the paraboloid gradually from vertically to horizontally, such that the water can be sprayed farther. Also, the water may become tangent to the tension eliminator 12 in the diverting process, and since the thickness of the tension eliminator 12 gradually increases from top to bottom, and also gradually increases from the central portion 14 to the edge portion 15 of the water-facing surface 13, the water flow can be gradually divided by the tension eliminator 12 when flowing on the water-facing surface 13. Moreover, the resistance encountered by the water flow is small and the water flow is divided by the tension eliminator 12, thereby preventing the water flow from concentratedly flowing in one direction. Therefore, the fluid diverting accelerator according to the present application can spray water flows more standard and more uniformly.

Further, multiple tension eliminators 12 are provided and are distributed on the water-facing surface 13 in a circumferential direction with the central portion 14 as the center of a circle.

With such an arrangement, the water flow on the water-facing surface 13 can be divided into multiple water flows, and the connection between the multiple water flows is cut off, such that the water flow can be distributed more uniformly.

In a preferred solution of this embodiment, the above tension eliminator 12 is a triangular cone with a first vertex 17, a second vertex 18, a third vertex 19 and a fourth vertex 20. A line connecting any two vertices is an edge of the triangular cone.

Specifically, the first vertex 17, the second vertex 18 and the third vertex 19 are arranged on the water-facing surface 13, the first vertex 17 is close to the central portion 14, the second vertex 18 and the third vertex 19 are close to the edge portion 15, and the fourth vertex 20 protrudes from the water-facing surface 13.

With such an arrangement, the triangular conical shaped tension eliminator 12 is capable of dividing the water flow obviously while causing less resistance to the water flow.

Moreover, a projection of the fourth vertex 20 in the vertical direction is beyond the water-facing surface 13, that is, the projection of the fourth vertex 20 in the vertical direction is outside a plane surrounded by the edge portion 15, that is, the fourth vertex protrudes outside a cylinder where the water-facing surface is located. With such an arrangement, the separated water flows can be prevented from recombining under tension, thereby further improving the flow division effect.

In order to divide the flow uniformly, a line connecting the first vertex 17 with the second vertex 18 has a length equal to the length of a line connecting the first vertex 17 with the third vertex 19, that is, the triangle defined by the first vertex 17, the second vertex 18 and the third vertex 19 is an isosceles triangle. The fourth vertex 20 is located on a symmetry plane of the isosceles triangle, arranged as such, the edge formed by the first vertex 17 and the fourth vertex 20 is on a symmetry plane of the tension eliminator 12, and the edge can equally divide the water flow into two flows.

It should be noted that, in this embodiment, the line connecting the fourth vertex 20 and the first vertex 17 is tangent to the water through hole 16 or intersects with the center line of the water through hole 16. This arrangement allows an extension direction of the tension eliminator 12 to substantially coincide with the flowing direction of the water flow, and can further reduce the resistance induced by the tension eliminator 12 to the water flow.

In this embodiment, in the case that the diverting accelerator includes multiple stages of diverting accelerators, for ease of connection, two adjacent stages of the diverting accelerators may be connected by a first connecting post 23, and all the diverting accelerators and the first connecting post 23 are connected into an integrated structure by injection molding. In this way, it is convenient to connect the stages of the diverting accelerators together.

In order to conveniently connect the spray tube 21 to the diverting accelerator 11 at the lower side of the spray tube, a flange 25 may be provided at a lower part of the spray tube 21, and the flange 25 and the spray tube 21 may be connected into an integrated structure by injection molding. The uppermost stage of the diverting accelerator 11 is connected to the flange 25 by a second connecting post 24. Specifically, the flange 25 may be provided with a snap joint protrusion, and the second connecting post 24 may be provided with a snap groove. It is convenient to connect the flange and the second connecting post together by snap.

In a preferred solution of this embodiment, the spray tube 21 has an inner diameter gradually decreased from top to bottom. With such an arrangement, the sprayed water flow has sufficient water pressure to be sprayed on the diverting accelerator 11, thereby achieving a better diffusion effect.

The variable flow rate spray nozzle having flow guiding and diffusing functions according to the present application is described in detail hereinbefore. The principle and the embodiments of the present application are illustrated herein by specific examples. The above description of examples is only intended to help the understanding of the method and concept of the present application. It should be noted that, for the person skilled in the art, a few of modifications and improvements may be made to the present application without departing from the principle of the present application, and these modifications and improvements are also deemed to fall into the scope of protection of the present application defined by the claims.

1. A variable flow rate spray nozzle having flow guiding and diffusing functions, comprising:
a spray tube provided with a water inlet at an upper part of the spray tube and a water outlet at a bottom part of the spray tube;
a diverting accelerator connected to a lower side of the spray tube; and
a tension eliminator arranged on the diverting accelerator,
wherein a water-facing surface of the diverting accelerator has a central portion higher than an edge portion of the water-facing surface, and the central portion of the water-facing surface is transitioned to the edge portion through a paraboloid for guiding the water flow flowing down in a vertical direction to be gradually diverted into a horizontal direction through the paraboloid, the tension eliminator protrudes from the water-facing surface, and the tension eliminator has a first end close to the central portion and a second end close to and protruding from the edge portion, and the tension eliminator has a thickness gradually increasing from top to bottom and gradually increasing from the central portion to the edge portion of the water-facing surface.

2. The variable flow rate spray nozzle having flow guiding and diffusing functions according to claim 1, wherein the water outlet of the spray tube is smaller than the water inlet, and an inner side wall of the spray tube is provided with a spiral guiding groove, and the water flowing into the spray tube flows downward in a spiral direction along the spiral guiding groove.

3. The variable flow rate spray nozzle having flow guiding and diffusing functions according to claim 1, wherein a plurality of tension eliminators is provided, and the plurality of tension eliminators are distributed on the water-facing surface in a circumferential direction with the central portion being as the center of a circle.

4. The variable flow rate spray nozzle having flow guiding and diffusing functions according to claim 1, wherein each of the tension eliminators is a triangular cone having a first vertex, a second vertex, a third vertex and a fourth vertex, and a line connecting any two vertices is an edge of the triangular cone, the first vertex, the second vertex and the third vertex are arranged on the water-facing surface, and the first vertex is close to the central portion, the second vertex and the third vertex are close to the edge portion, and the fourth vertex protrudes from the water-facing surface.

5. The variable flow rate spray nozzle having flow guiding and diffusing functions according to claim 4, wherein the projection of the fourth vertex in the vertical direction is beyond the water-facing surface.

6. The variable flow rate spray nozzle having flow guiding and diffusing functions according to claim 5, wherein a length of a line connecting the first vertex with the second vertex is equal to a length of a line connecting the first vertex with the third vertex, and the fourth vertex is located on a symmetry plane of a triangle defined by the first vertex, the second vertex, and the third vertex.

7. The variable flow rate spray nozzle having flow guiding and diffusing functions according to claim 6, wherein a line connecting the fourth vertex with the first vertex is tangent to a water through hole.

8. The variable flow rate spray nozzle having flow guiding and diffusing functions according to claim 6, wherein a line connecting the fourth vertex with the first vertex intersects with a centerline of the water through hole.

9. The variable flow rate spray nozzle having flow guiding and diffusing functions according to claim 1, wherein the central portion of the diverting accelerator is provided with a water through hole which penetrates the central portion in the vertical direction, and the water through hole of a lower stage has a diameter smaller than a diameter of the water through hole of an upper stage.

10. The variable flow rate spray nozzle having flow guiding and diffusing functions according to claim 9, wherein the water through hole is a taper hole whose diameter gradually decreases from top to bottom, and a section of an upper port of the water through hole is an acute angular edge.

11. The variable flow rate spray nozzle having flow guiding and diffusing functions according to claim 1, wherein the diverting accelerator comprises at least two stages of diverting accelerators, and the stages of diverting accelerators are distributed in the vertical direction, and each of the stages of diverting accelerators is provided with the tension eliminator.

12. The variable flow rate spray nozzle having flow guiding and diffusing functions according to claim 2, wherein the diverting accelerator comprises a plurality of stages of diverting accelerators, each of the stages of diverting accelerators is provided with the tension eliminator, and the plurality of stages of diverting accelerators are sequentially connected in the vertical direction.

13. The variable flow rate spray nozzle having flow guiding and diffusing functions according to claim 12, wherein two adjacent stages of diverting accelerators are connected by a first connecting post.

14. The variable flow rate spray nozzle having flow guiding and diffusing functions according to claim 13, wherein a lower part of the spray tube is provided with a flange and an uppermost stage of diverting accelerator is connected to the flange by a second connecting post.

15. The variable flow rate spray nozzle having flow guiding and diffusing functions according to claim 14, wherein the flange and the second connecting post are snapped together by a snap joint and a snap groove.

16. The variable flow rate spray nozzle having flow guiding and diffusing functions according to claim 2, wherein each of the tension eliminators is a triangular cone having a first vertex, a second vertex, a third vertex and a fourth vertex, and a line connecting any two vertices is an edge of the triangular cone, the first vertex, the second vertex and the third vertex are arranged on the water-facing surface, and the first vertex is close to the central portion, the second vertex and the third vertex are close to the edge portion, and the fourth vertex protrudes from the water-facing surface.

17. The variable flow rate spray nozzle having flow guiding and diffusing functions according to claim 3, wherein each of the tension eliminators is a triangular cone having a first vertex, a second vertex, a third vertex and a fourth vertex, and a line connecting any two vertices is an edge of the triangular cone, the first vertex, the second vertex and the third vertex are arranged on the water-facing surface, and the first vertex is close to the central portion, the second vertex and the third vertex are close to the edge portion, and the fourth vertex protrudes from the water-facing surface.
